(19) United States
(12) Patent Application Publication
(10) Pub. No.: US 2012/0324620 A1
(43) Pub. Date: Dec. 27, 2012

(54) Device, System And Method For Multi-Layered Weatherproof Touchscreen Glove

(75) Inventor: Robert Murphy, Poway, CA (US)

(73) Assignee: Seirus Innovative Accessories, Inc., Poway, CA (US)

(21) Appl. No.: 13/529,982

(22) Filed: Jun. 21, 2012

Related U.S. Application Data
(60) Provisional application No. 61/499,303, filed on Jun. 21, 2011.

(51) Int. Cl. A41D 19/00; H01B 7/28; A41D 19/02

(52) U.S. Cl. 2/159; 2/169; 174/110 R

(57) ABSTRACT

An electronic touchscreen operative glove, providing a conductive path from the skin to the exterior of the glove, so one need not remove the present glove to operate a touchscreen. The conductive path can be provided from the skin to one or more conductive panels on the tips of one or more finger and/or thumb of the glove. The glove can include one or more layers, preferably an inner and outer layer, the inner layer being weatherproof, and the outer layer forming the exterior of the glove, and having the conductive panels that can operate a touchscreen.

### CROSS REFERENCE TO RELATED APPLICATIONS

This application claims priority of U.S. Provisional Patent Application No. 61/499,303 filed 21 Jun. 2011, the entire contents and substance of which are hereby incorporated by reference.

### BACKGROUND OF THE INVENTION

1. Field of the Invention

The present invention relates to a glove that can operate a touchscreen device, so the user does not need to remove the glove to operate an electronic touchscreen device. The glove provides the ultimate in convenience, and is designed to offer a barrier to wind and water, a customizable degree of breathability, and/or provide insulative properties from winter sports to winter street wear.

2. Description of Related Art

Touchscreen devices (including but not limited to iPhones®, iPads®, cash register checkouts, ATM machines, gas pumps, etc.) typically operate by surface capacitance. Specifically, a small voltage is applied to the screen which results in a uniform electrostatic field.

When a conductor (such as a human finger or mechanical stylus) touches the screen, the capacitance of the screen changes. The control system on the touchscreen then typically determines the location of the “touch” by measuring the capacitance from each of the four corners of the touchscreen panel. Touching the screen at different locations will vary the capacitance as measured from each of the four corners.

Human hands have a relatively high electrical conductivity (due to the high fluid content of human tissue). As a result, fingers and/or thumbs easily vary the capacitance of the touchscreen—and thus can be used to control the device.

In contrast, gloves have a relatively high electrical resistance (i.e., low conductivity). This is true both in the case of knit fabric gloves and in the case of weatherproof gloves. Since these gloves do not conduct electricity, they cannot be used effectively to vary the capacitance of the touchscreen.

As a result, presently it is necessary for a person to remove his/her winter gloves prior to operating a standard touchscreen device. It would instead be more desirable to provide a glove through which a person could operate a touchscreen device. This is especially true in colder climates or when involved in outdoor winter sports (such as skiing or skating). Thus, it is to such a system, device and method that the present invention is primarily directed.

### BRIEF SUMMARY OF THE INVENTION

Briefly described, in a preferred form, the present invention is an electronic touchscreen operative glove, providing a conductive path from the skin to the exterior of the glove, so one need not remove the present glove to operate a touchscreen. As used herein, the term glove means a hand covering, for example, a mitten, a fingered glove, and the like. In a preferred embodiment, a conductive path is provided from the skin to one or more conductive pads or panels on the tips of one or more fingers and/or thumb of the glove. The glove can include one or more layers, preferably at least one of the layers being weatherproof, wherein at least one conductive panel is located on the exterior of the glove so that the user can reliably operate a touchscreen without removing the glove.

In one exemplary embodiment, the present invention is a weatherproof membrane having an inner surface and an outer surface, the weatherproof membrane comprising a conductive path formed by a protrusion of conductive material extending inside and outside the weatherproof membrane.

As used herein, it will be understood by those of skill in the art that a protrusion of material extending inside and outside a layer, or extending through a layer, discloses constructions that incorporate a structure physically extending inside and outside the layer, or extending through the layer. In the present case, the structure “physically” extending inside and outside the layer, or extending through the layer, provides a conductive path through the layer.

This is understood to be patentably distinct from other types of constructions that, while perhaps providing a conductive path through layer(s), does so by, for example, layering materials one atop another, that when all are in physical contact, might provide a conductive path through the layer, but do not do so via “a protrusion of conductive material extending inside and outside” the layer. This feature is but one of numerous patentable features the present glove incorporates over the conventional art.

In a non-limiting example of this patentable distinction, it may be known to provide a single glove layer that itself is formed of a conductive material, and therefore if fit over a hand of a user, would provide a conductive path from the finger of the user, through the layer itself (as it is conductive), and ultimately to the exterior surface of the glove layer, without more. This is not an example of a layer “comprising a conductive path formed by a protrusion of conductive material extending inside and outside the” layer as disclosed herein.

Even if pads or panels were located inside and outside such a conductive glove layer to more reliably present a conductive path no matter the size of the user's hand (finger, to internal pad, to conductive glove layer, to external pad), this layered construction also is not an example of a layer “comprising a conductive path formed by a protrusion of conductive material extending inside and outside the” layer as disclosed herein.

It will be further understood that the present invention is patentably distinct from other types of constructions that, while perhaps providing a conductive path through layer(s), does so by, for example, cutting apertures in otherwise layers that render the glove less optimal. In one example, a conventional construction might provide the conductive path from skin to glove exterior by removing ample amounts of insulation that would otherwise break the conductive path, but this of course compromises the insulative properties of the glove. The present invention provides a glove that if incorporating an amount of insulation, the insulation is not disturbed or otherwise chopped away or removed to make room for a bulky conductive path. The present invention provides a conductive path that skirts around the insulation, or otherwise avoids disturbing the insulative properties of such a glove. Thus, a multi-layered glove of the present invention can incorporate insulation in proximity of one or both of the ends of the conductive path, wherein conventional gloves have the insulation removed from the ends of the conductive path.

In another exemplary embodiment, the present invention is a glove comprising at least one layer providing a conductive path from the skin of the user to the exterior of the glove, so the user need not remove the glove to operate a touchscreen. The layer can comprise a weatherproof membrane having an inner surface and an outer surface, the inner surface positionable in communication with a user's skin, the weatherproof membrane comprising a conductive path formed by a protrusion of conductive material extending through the weatherproof membrane to the exterior of the glove. The protrusion of conductive material extending through the weatherproof membrane preferably does not compromise the weatherproofing of the membrane. The conductive material can be welded into a seam of the layer, or otherwise formed in the manufacturing process of the layer to provide a weatherproof and/or thermally protective layer while providing the user with one or more conductive panels on the exterior of the layer.

In another exemplary embodiment, the present invention comprises more than one layer. In these embodiments, the conductive path from skin to exterior of the glove must be maintained, so the inventive multi-layer glove incorporates innovative technology to each layer, and in the manufacturing process, to enable the wearer to operate an electronic touchscreen without removing their glove(s).

In another exemplary embodiment, the present invention comprises a glove capable of operating a touchscreen, a system of touchscreen control with a glove, a method of controlling a touchscreen with a glove, and a method of manufacturing a glove capable of operating a touchscreen.

The glove can comprise one layer, but in more preferred embodiments, comprises two or more layers.

For example, the glove can comprise three layers:
an inner layer;
a weatherproof membrane layer positioned around the inner layer; and
a glove shell layer positioned around the weatherproof membrane layer.

It will be understood that the glove of the present invention can include one or more of the above layers, and/or can include other layers not specifically recited above, for example, an insulative layer. Further, it will be understood by those of skill in the art that while the layers are discussed generally herein as separate, discrete layers, the glove of the present invention need not necessary include, for example, three layers as outlined above, but could include one integral layer of a material that includes an inner surface, weatherproofing, and an exterior glove shell, that might be considered one “layer” of material.

In the exemplary three layer glove, the inner layer form fits to the user's skin, preferably the entire hand, the weatherproof membrane layer cooperative fits over the inner layer, and the glove shell layer cooperatively fits over the weatherproof membrane layer, so the glove provides the user with the required durability and water and thermal needs, while providing a conductive path from skin to the exterior of the glove.

The innovative conductive path from skin to the exterior of the glove of the present invention can comprise a tab of conductive material through the weatherproof membrane layer, a conductive path passing from the tab of conductive material into the interior of the inner layer, and a conductive path passing from the tab of conductive material to at least one conductive panel of the exterior of the glove shell layer.

In an exemplary embodiment, the present invention is a glove for a hand comprising an inner surface and an outer surface, the inner surface positionable in communication with a user's skin, the glove comprising a conductive path from a user's skin within the glove to the outer surface. The conductive path can comprise a conductive panel forming a portion of the outer surface of the glove. The glove can comprise a weatherproof membrane layer having a portion of conductive material forming a portion of the conductive path. At least a portion of the conductive material can be inserted in a welded seam of the weatherproof membrane layer.

The glove can further comprise an inner layer, the inner layer having the inner surface positionable in communication with a user's skin, and the weatherproof membrane layer positionable over the inner layer.

The glove can further comprise a glove shell layer having the outer surface forming the exterior of the glove, the glove shell layer positionable over the weatherproof membrane layer, wherein the conductive path comprises a conductive panel forming a portion of the outer surface of the glove shell layer.

In another exemplary embodiment, the present invention is a multi-layered glove configured to operate a touchscreen device, the glove comprising an inner layer having an interior and exterior, a weatherproof membrane layer having an interior and exterior, the interior of the weatherproof membrane layer in proximity to the exterior of the inner layer, a glove shell layer having an interior and exterior, the interior of the glove shell layer in proximity to the exterior of the weatherproof membrane layer, and a conductive path extending from a portion of the interior of the inner layer to a portion of the exterior of the glove shell layer.

The conductive path can comprise conductive material through the inner layer. The conductive path can comprises conductive material protruding through the weatherproof membrane layer. Further, the conductive material protruding through the weatherproof membrane layer can comprise a strip of conductive material inserted in a welded seam of the weatherproof membrane layer. Additionally, the conductive path can comprise a conductive panel forming a portion of the exterior of the glove shell layer. The conductive path can further comprise conductive fibers.

The conductive path can comprise a tab of conductive material in communication between the interior of the inner layer through the weatherproof membrane layer, and continue to a conductive panel forming a portion of the exterior of the glove shell layer, wherein the tab of conductive material is in a conductive path with the conductive panel, thus forming a conductive path from a user's skin to the conduct panel when the glove is worn by a user.

Preferably, the conductive path comprises conductive material extending from a portion of the interior of the inner layer to a portion of the exterior of the glove shell layer, wherein the conductive material does not compromise the weatherproofing of the glove provided by the weatherproof membrane layer. Additionally, the conductive material does not compromise the insulation content or coverage of the glove as a whole.

The inner layer can comprise fabric, and the multi-layered glove can further comprise an insulative layer.

The weatherproof membrane layer can comprise the shape of a hand, as can all layers of the glove, and the conductive panel forming a portion of the exterior of the glove shell layer can be located in proximity to a finger or thumb tip of the glove.

In another exemplary embodiment, the present invention is a multi-layered glove configured to operate a touchscreen device, the glove comprising three or more layers comprising an inner layer having an interior and exterior, a weatherproof membrane layer having an interior and exterior, the interior of the weatherproof membrane layer in conductive communication with the exterior of the inner layer, and a glove shell layer having an interior and exterior, the interior of the glove shell layer in communication with the exterior of the weatherproof membrane layer, the glove further comprising at least one tab of conductive material through the weatherproof membrane layer, and at least one region of conductive material positioned on the exterior of the glove shell layer. The tab of conductive material through the weatherproof membrane layer and the region of conductive material positioned on the exterior of the glove shell layer forms a conductive path communicative between a user's skin and the exterior of the glove shell layer.

At least one of the at least one region of conductive material positioned on the exterior of the glove shell layer can comprises a finger or thumb conductive panel. The inner layer can comprise fabric, and the glove can incorporate other layers.

A tab of conductive material can comprise a strip of material inserted in a welded seam in, or otherwise through, the weatherproof membrane layer. A tab of conductive material can be sewn onto the inner fabric layer during assembly of the glove. A tab of conductive material can be, for example, sewn, molded, woven, and/or welded onto at least one finger or thumb conductive panel on the exterior of the glove shell layer during assembly of the glove.

In various exemplary embodiments, the tab of conductive material can be positioned adjacent to the user's finger (or thumb) tips. It is to be understood, however, that the present invention is not so limited. For example, the entire inner and/or outer layers can be made of any electrically conductive material, including but not limited to, electrically conductive plastics and nylon. In yet other embodiments, the portion of the inner layer that is electrically conductive (or that is near to a conductive tab) can include regions near the sides, back or front of the hand, and/or around the cuff.

In another aspect of the present invention, a method of making a multi-layered glove configured to operate a touchscreen device comprises providing an inner layer, providing a weatherproof membrane layer, providing a protrusion of conductive material extending through the weatherproof membrane layer, providing a glove shell layer, and extending a conductive path from a portion of an interior of the inner layer to a portion of an exterior of the glove shell layer.

The protrusion can comprise a conductive tab that provides a conductive path through weatherproof membrane layer. The method can further comprise providing more than one conductive tabs through the weatherproof membrane layer, wherein one or more of the conductive tabs provide a conductive path through weatherproof membrane layer, attaching one or more conductive tabs onto the inner fabric layer with a conductive material therethrough, into the inside of the inner layer, at a location proximal to a user's skin (in a preferred embodiment, the user's hand or portions thereof), positioning the weatherproof membrane layer around the inner layer, attaching at least one region of conductive material onto an exterior of the glove shell layer, attaching at least one region of conductive material to one or more conductive tabs with a conductive material, and positioning the glove shell layer around the weatherproof membrane layer.

The method can further comprise positioning the weatherproof membrane layer over the inner layer, and positioning the glove shell layer over the weatherproof membrane layer. Positioning the weatherproof membrane layer over the inner layer can involve flipping the weatherproof membrane layer inside-out over the inner layer after the conductive tabs have been sewn onto the inner layer.

Positioning the glove shell layer over the weatherproof membrane layer can involve flipping the glove shell layer inside-out over the weatherproof membrane layer and inner layer after at least one finger or thumb conductive panel has been sewn onto conductive tabs.

The conductive path can extend from a first end being the portion of the interior of the inner layer to a second end being the portion of the exterior of the glove shell layer, and the method further comprise thermally insulating one or both of the ends of the conductive path.

These and other objects, features and advantages of the present invention will become more apparent upon reading the following specification in conjunction with the accompanying drawing figures.

### BRIEF DESCRIPTION OF THE DRAWINGS

Various features and advantages of the present invention may be more readily understood with reference to the following detailed description taken in conjunction with the accompanying drawings, wherein like reference numerals designate like structural elements, and in which:

FIG. 1 is a view of a weatherproof membrane layer and the connective tabs of a glove of the present invention, according to an exemplary embodiment.

FIG. 2 is a view of a weatherproof membrane layer attachable to an inner fabric layer of a glove of the present invention, according to an exemplary embodiment.

FIG. 3 is a view of a weatherproof membrane layer after it has been pulled inside-out over an inner fabric layer of a glove of the present invention, according to an exemplary embodiment.

FIG. 4 is a view of a weatherproof membrane layer being attachable to a glove shell layer of a glove of the present invention, according to an exemplary embodiment.

FIG. 5 is a view of a glove shell layer after it has been pulled inside-out over a weatherproof membrane layer of a glove of the present invention, according to an exemplary embodiment.

FIG. 6 is a view of an illustration of a multi-layered weatherproof touchscreen glove according to an exemplary embodiment.

### DETAILED DESCRIPTION OF PREFERRED EMBODIMENTS

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or examples. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

In a preferred form, the present invention is a multi-layered article of clothing for a hand configured to operate a touchscreen device. The article can comprise a mitten, or other form of hand covering, for example, one that separately clothes fingers one from another, like a conventional five fingered glove (wherein the term finger includes a thumb).

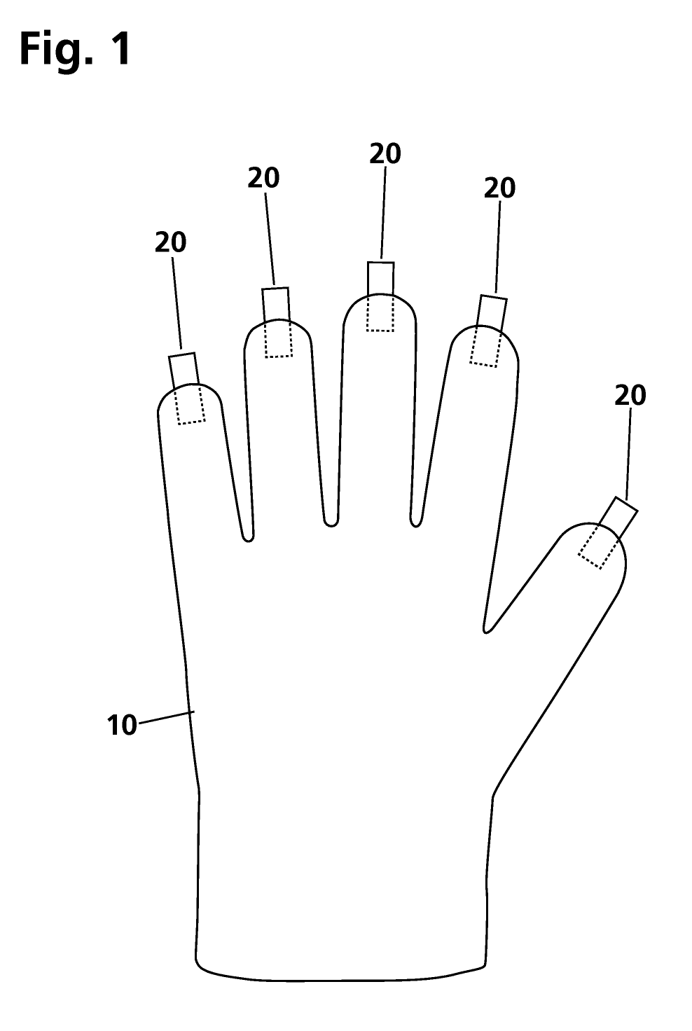

As seen in FIG. 1, a weatherproof membrane layer 10 is provided. Weatherproof membrane layer 10 can be a hollow glove like shape dimensioned to receive a hand therein. A glove in the shape of a hand is used in this exemplary embodiment. However, those with skill in the art will appreciate that a glove is not limited to the shape of a hand (e.g., a glove can also take on the shape of a mitten). To provide a path a conductive path from the user's skin to ultimately the exterior of the glove (whether it is formed of one or more layers), one or more electrically conductive tabs 20 can be formed into the ends of the finger/thumb portions as shown. (The dotted line portions of conductive tabs 20 project inside membrane 10, while the solid line portions of conductive tabs 20 project outside membrane 10.) In this exemplary embodiment, conductive tabs 20 comprise a protrusion of material forming a portion of the weatherproof membrane layer, whether it is formed integrally upon membrane 10 manufacture, or provided to the membrane 10 during or after membrane 10 manufacture, for example, inserted in a welded seam in the weatherproof membrane layer.

Electrically conductive tabs 20 can comprise various materials, including, but not limited to, plastics, metals, gels, and leathers. Those of skill in the art will appreciate the various materials capable of conducting electricity.

Furthermore, it is to be understood that the present invention encompasses embodiments with various number of conductive tabs 20. In this exemplary embodiment, one electrically conductive tab 20 is provided per finger of the glove. However, the number of conductive tabs 20 can vary. For example, the present invention can comprise one finger or thumb tab 20 that is made of a conductive material. Alternatively, conductive tabs 20 can be provided for all fingers and the thumb, as desired. Additionally, conductive tabs 20 can be positioned at a variety of portions of the weatherproof membrane layer 10. For example, and not limitation, conductive tabs 20 can be placed along the knuckles or palm.

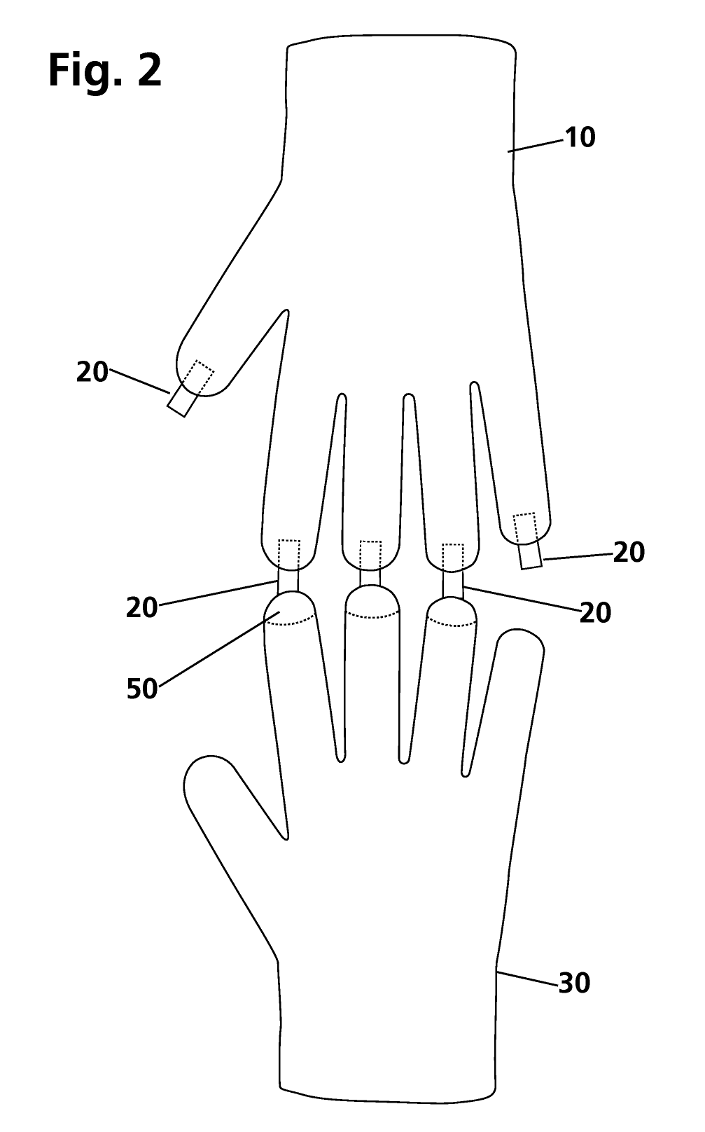

Next, as seen in FIG. 2, a hollow inner liner 30 is positionable within the weatherproof membrane layer 10. As shown, the weatherproof membrane layer 10 and conductive tabs 20 can be attached onto ends of the inner liner 30 using electrically conductive material. (At this stage, the weatherproof membrane layer 10 is inside-out.)

Preferably, inner layer 30 comprises fabric; however, the present invention can comprise many suitable materials. To maintain the innovative conductive path from skin to the exterior of the glove, the electrically conductive material can project into the interior regions of inner layer 30 (to provide the conductive path with the user's skin). In another exemplary embodiment, conductive tabs 20 can be attached at other portions of the glove.

FIG. 2 illustrates a mid-way step where only three fingertips being connected together. It is to be understood that each fingertip/thumbtip region will be connected together one after another. As stated above, a conductive tab 20 can be disposed on one finger. In such a case, the other fingertips from the inner layer 30 and weatherproof membrane layer 10 can be attached together. In yet another embodiment, the majority of the inner layer 30 comprises an electrically conductive material, with a conductive path being provided between the user's skin, through the electrically conductive inner layer 30 and into the conductive tabs 20, and ultimately to an outer layer of the glove (should it incorporate more than one layer). There are various methods to attach inner layer 30 and weatherproof membrane layer 10. In an exemplary embodiment, inner layer 30 and weatherproof membrane layer 10 can be simply sewn together. In another exemplary embodiment, inner layer 30 and weatherproof membrane layer 10 can be attached using an adhesive. Furthermore, the connective material can comprise of conductive or non-conductive materials.

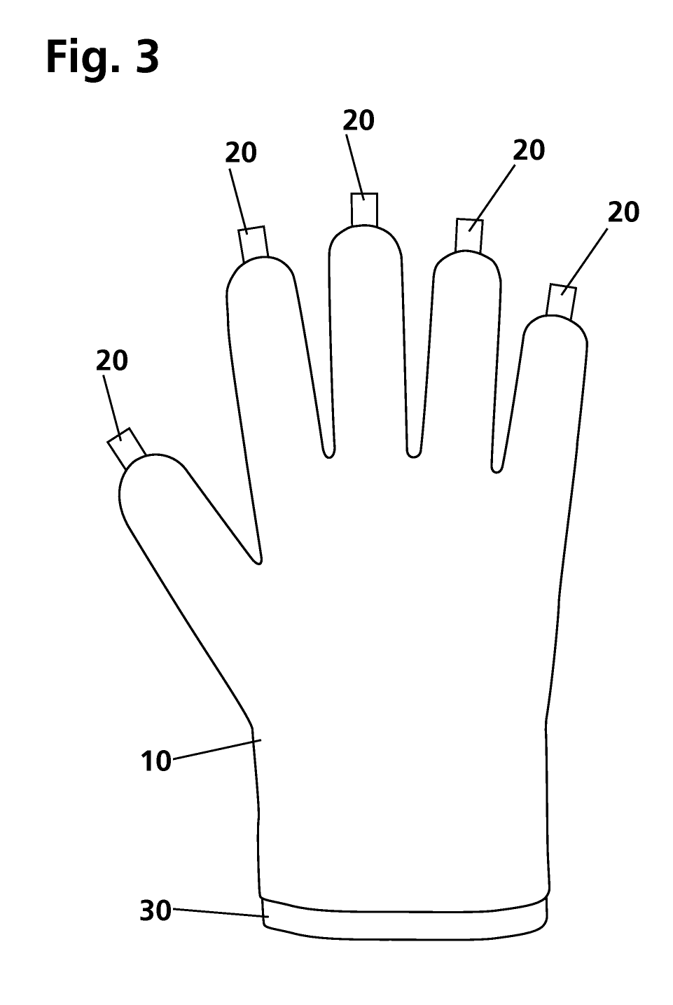

Next, as seen in FIG. 3, weatherproof membrane layer 10 can be pulled inside-out over inner layer 30. As can be seen, the portions of conductive tabs 20 that were previously inside weatherproof membrane layer 10 (in FIG. 1), now protrude outwardly, as shown. The conductive tabs 20 thus are one embodiment to form the conductive path from skin to the exterior of the weatherproof membrane layer 10, while those of skill in the art will appreciate that other embodiments to form the conductive path from skin to the exterior of the weatherproof membrane layer 10 are within the scope of the present invention.

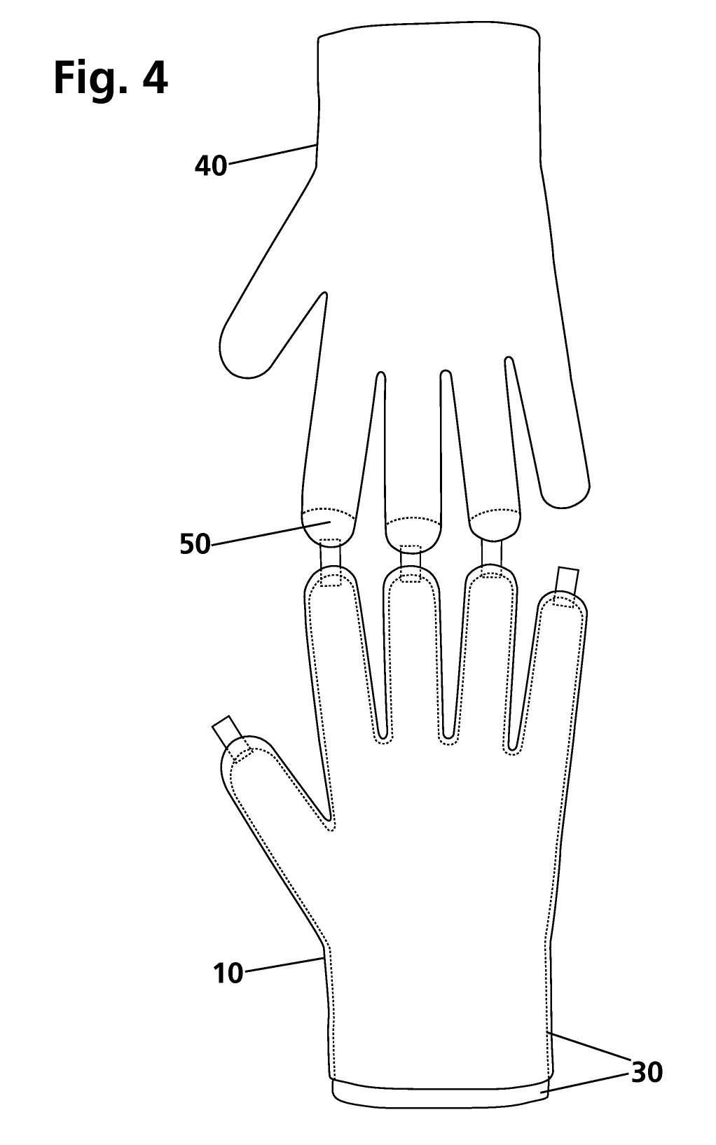

Next, as seen in FIG. 4, a glove shell layer 40 can be positioned in proximity to weatherproof membrane layer 10, and the conductive path continued from the user's skin to the exterior of the glove shell layer 40, and provided in many forms, one having the conductive tabs 20 attached onto/into conductive panels of the glove shell layer 40 using electrically conductive material. (As this stage, exterior of the glove shell layer 40 is inside-out).

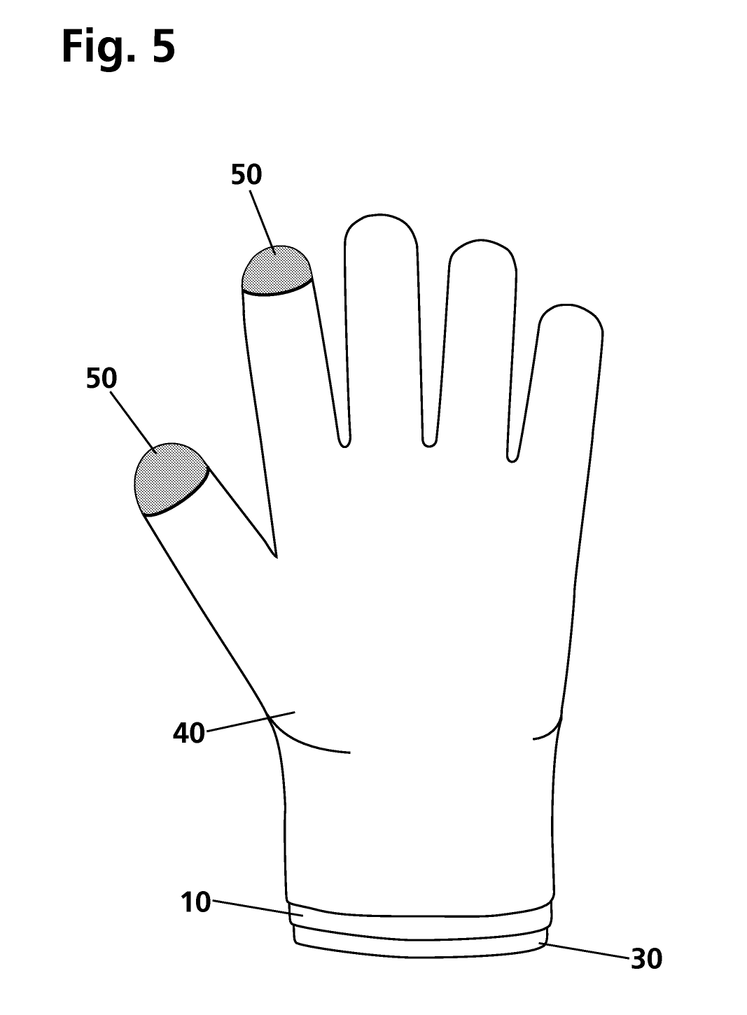

Next, as seen in FIG. 5, exterior of the glove shell layer 40 can be pulled inside-out over the weatherproof membrane layer 10. One or more finger or thumb conductive panels 50 of conductive material can be disposed on the outside of exterior of the glove shell layer 40. In various embodiments, finger/thumb conductive panels 50 can be attached onto the exterior of the exterior of the glove shell layer 40. Alternatively, finger/thumb conductive panels 50 can be attached onto open ends of the finger/thumb regions of the exterior of the glove shell layer 40. In various embodiments, portions 50 need not be “panels”, but can instead include many other portions/geometries/areas on the exterior of the glove. As such, not only finger tips and thumb tips can be used to control touchscreen devices. For example, if a large portion (or all) of the outer material is conductive, then a user could work with a touchscreen device using other parts of their hands (i.e.: knuckles, wrist, back of the hand, etc). Conductive material is used such that finger/thumb conductive panels 50 are in electrical contact with the ends of the user's fingers (with the electrical contact passing from the fingers/thumb, through the conductive material on the inside of inner layer 30, through conductive tabs 20 and then through conductive material and into finger/thumb conductive panels 50). The number of conductive finger/thumb conductive panels 50 can be the same as the number of conductive tabs 20. Note: FIG. 5 shows end portions of weatherproof membrane layer 10 and inner liner 30. This is for illustration purposes only to show how the present invention provides a multi-layer, weatherproof glove that can be used to operate a touchscreen device.

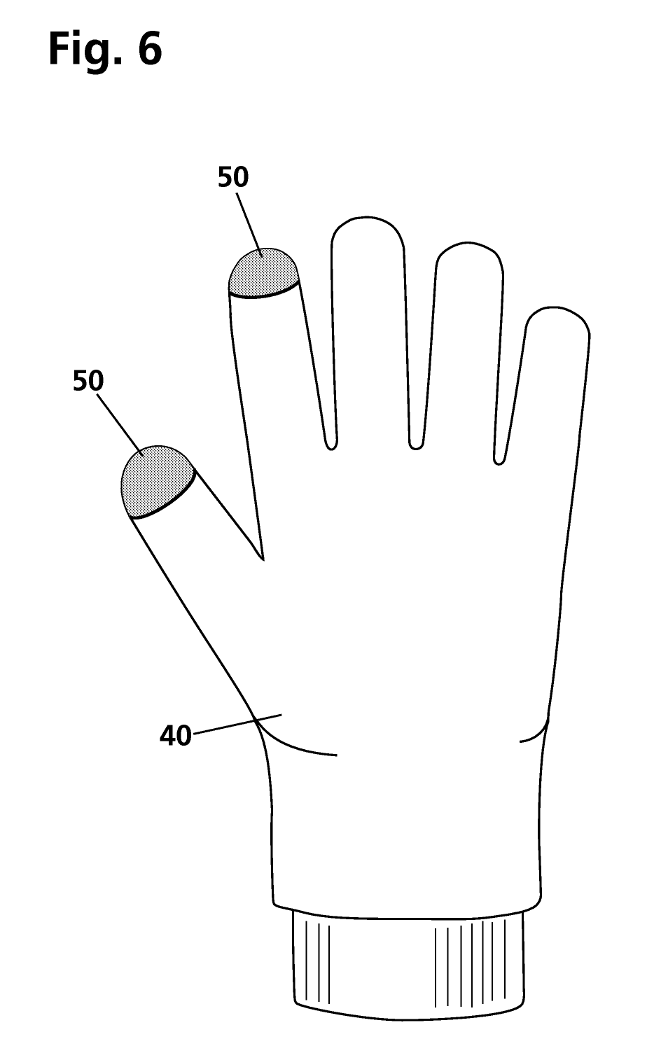

Finally, as seen in FIG. 6, a complete multi-layered weatherproof touchscreen glove is provided. Exterior of the glove shell layer 40 completely covers weatherproof membrane layer 10 and inner layer 30. An optional elastic cuff section is added and positioned around the user's wrist. In this exemplary embodiment, the exterior of the glove shell layer 40 is longer than the weatherproof membrane layer 10 and inner liner 30 and pulls over the inner layers. The multi-layered nature of this weatherproof touchscreen glove allows for many advantages, including but not limited to, insulation, grip, and protection. Those of skill in the art will appreciate the many advantages of a multilayered, weatherproof touchscreen glove as defined by this invention. The exemplary embodiment illustrated in FIG. 5-6 provide three layers, specifically an inner layer 30, a weatherproof membrane layer 10, and an exterior of the glove shell layer 40. However, it will be apparent to those skilled in the arts that additional layers can be added.

Additionally, the conductive path from the user's skin to the exterior of the glove need not be linearly orientated from the same portion of skin to the same portion of the glove. For example, it is not necessary that an index finger conductive panel be in conductive communication with the user's index finger. In alternative embodiments, the conductive path to an index finger conductive panel can originate, for example, at the user's palm, or the back of the hand. To operate an electronic touchscreen device without removing the glove, it is only necessary that the conductive path ending in one or more conductive panels on the exterior of the glove begin with communication with the user's skin, but that point of origination can be in a variety of locations about the skin.

The exemplary embodiments provided in FIG. 1-6 illustrate conductive tabs 20 protruding through all three layers, and thus a one-to-one relationship between the number of points of communication with the skin, with the number of conductive panels. In various other embodiments of the present invention, the ratio need not be one-to-one, for example, when the glove comprises an inner layer that is at least partially, if not fully, formed of conductive material. In other embodiments, the glove can be designed with a conductive path that originates from a single location (for example, one location on the back of the hand), yet communicate with a plurality of terminals/conductive panels (for example, two or more finger tips).

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A wearable weatherproof membrane comprising a conductive path formed by a protrusion of conductive material extending through the weatherproof membrane.

2. The wearable weatherproof membrane of claim 1, the weatherproof membrane having an inner surface and an outer surface, the conductive path comprising a conductive panel forming a portion of the outer surface of the weatherproof membrane.

3. The wearable weatherproof membrane of claim 1, wherein the wearable weatherproof membrane comprises the shape of a hand, and wherein at least a portion of the conductive material is inserted in a welded seam of the hand-shaped weatherproof membrane layer.

4. A glove configured to operate a touchscreen device, the glove comprising the weatherproof membrane of claim 1.

5. A multi-layered glove configured to operate a touchscreen device, the glove comprising:
an inner layer having an interior and exterior;
a weatherproof membrane layer having an interior and exterior and a protrusion of conductive material extending therethrough, the weatherproof membrane layer in communication with the inner layer;
a glove shell layer having an interior and exterior, the glove shell layer in communication with the weatherproof membrane layer; and
a conductive path extending from a portion of the interior of the inner layer to a portion of the exterior of the glove shell layer.

6. The multi-layered glove of claim 5, wherein the conductive path comprises conductive material through the inner layer.

7. The multi-layered glove of claim 5, the conductive path extending from a first end being the portion of the interior of the inner layer to a second end being the portion of the exterior of the glove shell layer, the glove further comprising thermal insulation in proximity of one or both of the ends of the conductive path.

8. The multi-layered glove of claim 5, wherein the conductive material protruding through the weatherproof membrane layer comprises a strip of conductive material inserted in a welded seam of the weatherproof membrane layer.

9. The multi-layered glove of claim 5, wherein the conductive path comprises a conductive panel forming a portion of the exterior of the glove shell layer.

10. The multi-layered glove of claim 5, wherein the conductive path comprises conductive fibers.

11. The multi-layered glove of claim 5, wherein the conductive path comprises:
a tab of conductive material extending from the interior of the inner layer through the exterior of the weatherproof membrane layer; and
a conductive panel forming a portion of the exterior of the glove shell layer;
wherein the tab of conductive material is in a conductive communication with the conductive panel, thus forming the conductive path from a user's skin to the conductive panel when the glove is worn by a user.

12. The multi-layered glove of claim 5, wherein the conductive path comprises conductive material extending from a portion of the interior of the inner layer to a portion of the exterior of the glove shell layer, wherein the conductive material does not adversely affect the weatherproofing of the glove provided by the weatherproof membrane layer.

13. The multi-layered glove of claim 5, wherein the inner layer comprises fabric.

14. The multi-layered glove of claim 5 further comprising thermal insulation.

15. The multi-layered glove of claim 5, wherein the weatherproof membrane layer comprises the shape of a hand.

16. The multi-layered glove of claim 5, wherein the conductive panel forming a portion of the exterior of the glove shell layer is located in proximity to a finger or thumb tip of the glove.

17. A method of making a multi-layered glove configured to operate a touchscreen device, comprising:
providing an inner layer;
providing a weatherproof membrane layer;
providing a protrusion of conductive material extending through the weatherproof membrane layer;
providing a glove shell layer; and
extending a conductive path from a portion of an interior of the inner layer to a portion of an exterior of the glove shell layer.

18. The method of claim 17 further comprising:
positioning the weatherproof membrane layer over the inner layer; and
positioning the glove shell layer over the weatherproof membrane layer.

19. The method of claim 17, the conductive path extending from a first end being the portion of the interior of the inner layer to a second end being the portion of the exterior of the glove shell layer, the method further comprising thermally insulating one or both of the ends of the conductive path.
